(19) United States
(12) Patent Application Publication
(10) Pub. No.: US 2013/0307887 A1
(43) Pub. Date: Nov. 21, 2013

(54) IMAGE DISPLAY APPARATUS

(71) Applicant: Yoshihiro Hanada, Kanagawa (JP)

(72) Inventor: Yoshihiro Hanada, Kanagawa (JP)

(73) Assignee: Pioneer Corporation, Kanagawa (JP)

(21) Appl. No.: 13/982,652

(22) PCT Filed: Jan. 31, 2011
(86) PCT No.: PCT/JP2011/051954

§ 371 Date: Jul. 30, 2013

(51) Int. Cl. G09G 5/10

(52) U.S. Cl. CPC G09G 5/10
USPC 345/691

(57) ABSTRACT

An image display apparatus is provided to display a smoothly moving image with a high resolution that includes: a light source 60; a light source drive part 20 that drives the light source; a deflector that repeatedly scans light from the light source in predetermined Lissajous patterns; and a drive waveform generation part 40. One of the Lissajous patterns is constituted by a first field and a second field, the first field being formed by first scanning trajectories and the second field being formed by second scanning trajectories. The light source drive part 20 drives the light source 60 based on image data corresponding to a field rate that is a repetition frequency to repeat the first field and the second field; and the drive waveform generation part 40 controls the deflector such that main scanning position X and sub-scanning position Y hold relationships represented by following equations.

X=sin(2π·a·n/2·T), Y=sin(2π·(a+1)·n/2·T)

### CROSS-REFERENCES TO RELATED APPLICATIONS

This application claims the benefit of PCT International Patent Application No. PCT/JP/2011/051954 filed Jan. 31, 2011, which is incorporated herein by reference.

### BACKGROUND

1. Technical Field

The present invention relates to an image display apparatus, more particularly, to an image display apparatus configured to display images by scanning the light from a light source in Lissajous patterns.

2. Related Art

Conventionally, there has been known an image display apparatus configured to draw scanning lines using the laser light emitted to a MEMS mirror as disclosed, for example, in Patent Literature 1. The image display apparatus includes: a scanning line detection part that can detect the distance between at least two adjacent scanning lines in the sub-scanning direction (vertical direction) and detect a scanning direction in the main scanning direction (horizontal direction); and a control part that controls the phase of the deflection angle of a MEMS mirror such that the distance between the at least two adjacent scanning lines detected by the scanning line detection part is fixed in the sub-scanning direction and the directions of the two scanning lines are opposite to one another in the main scanning direction.

With this configuration, certainly it is possible to fix the distance between adjacent scanning lines, and therefore to accurately control Lissajous scanning. Accordingly, provided that the frequency in the main scanning direction is the same as the frequency in the sub-scanning direction, it is possible to prevent the distances between scanning trajectories from being uneven, and therefore to provide image display with higher image quality than in a case where the distances between scanning trajectories are uneven.

Patent Literature 1: Japanese Patent Application Laid-Open No. 2008-216299

However, in order to improve the resolution of an image displayed on such an image display apparatus configured to display the image by oscillating the MEMS mirror irradiated with laser light in two directions, a vertical direction and a horizontal direction, it is required to increase the oscillation frequency of the MEMS mirror in the main scanning direction and the sub-scanning direction. For example, in order to achieve the resolution with a frame rate of 60 fps and a horizontal resolution of 720 lines by the drawing (scanning) in the outward journeys and the return journeys of horizontal scanning, it is enough to resonate the MEMS mirror at an oscillation frequency of 21.6 kHz (60 fps×720÷2=21.6 kHz). However, in order to achieve a frame rate of 60 fps and a resolution with a horizontal resolution of 1080 lines to provide FHD (full high definition), it is required to acquire at least an oscillation frequency of 32.4 kHz(60 fps×1080÷2=32.4 kHz).

However, at present, the upper limit of the resonance frequency to oscillate a MEMS mirror is about 30 kHz due to its mechanical restriction. Therefore, it is difficult to oscillate the MEMS mirror at a resonance frequency equal to or higher than 32.4 kHz, which can acquire a resolution with a horizontal resolution of 1080 or more lines for FHD. Here, it is possible to reduce the oscillation frequency by reducing the frame rate while keeping the resolution per frame. However, with this method, it is difficult to draw a moving image with smooth motion.

### SUMMARY

The present invention was made in view of the above described problems, it is therefore an object of the present invention to provide an image display apparatus that can solve the problems.

To solve the above-described problems, the image display apparatus according to the present invention includes: a light source; a light source drive part configured to drive the light source; a deflector configured to repeatedly scan light from the light source in predetermined Lissajous patterns, operating in a main scanning direction and a sub-scanning direction that is different from the main scanning direction; and a drive waveform generation part configured to generate a signal to drive the deflector. One of the Lissajous patterns is constituted by a first field and a second field, the first field being formed by first scanning trajectories and the second field being formed by second scanning trajectories that are different from the first scanning trajectories. The light source drive part drives the light source based on image data corresponding to a field rate that is a repetition frequency to repeat the first field and the second field. The drive waveform generation part controls the deflector such that main scanning position

X in the main scanning direction, sub-scanning position Y in the sub-scanning direction, field rate n and time T hold relationships represented by following Equation 1 and Equation 2.

X=sin(2π·a·n/2·T), Y=sin(2π·(a+1)·n/2·T) Equation 1

X=sin(2π·(a+1)·n/2·T), Y=sin(2π·a·n/2·T) Equation 2

### BRIEF DESCRIPTION OF THE DRAWINGS

FIG. 1 is a block diagram showing the configuration of an image display apparatus according to one embodiment of the present invention;

FIG. 2 is a conceptual diagram showing the horizontal positions and the vertical positions in the Lissajous scanning of the image display apparatus according to one embodiment of the present invention;

FIG. 3 is a schematic view showing an exemplary Lissajous scanning (in the first field) of the image display apparatus according to one embodiment of the present invention;

FIG. 4 is a schematic view showing an exemplary Lissajous scanning (in the second field) of the image display apparatus according to one embodiment of the present invention; and

FIG. 5 is a schematic view showing an exemplary Lissajous scanning (for one frame) of the image display apparatus according to one embodiment of the present invention.

### DESCRIPTION OF EXEMPLARY EMBODIMENTS

Now, an embodiment of the present invention will be described in detail with reference to the drawings. For the sake of convenience, components having the same operational effect are assigned the same reference numerals, and overlapping descriptions will be omitted. The present invention is broadly applicable to an image display apparatus configured for Lissajous scanning, oscillating a deflector in the main scanning direction and the sub-scanning direction. Here, an exemplary image display apparatus will be described, which is configured for Lissajous scanning with a MEMS mirror based on the image data of raster scanning.

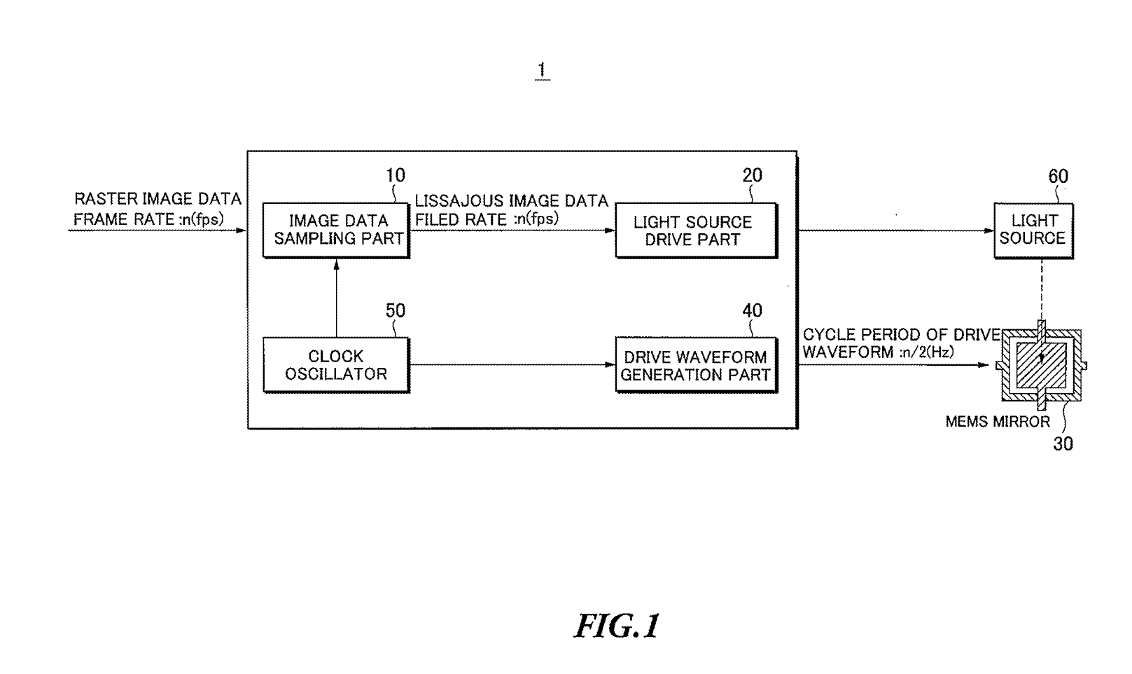

FIG. 1 shows a schematic block diagram showing the image display apparatus according to one embodiment of the present invention. An image display apparatus 1 according to the present embodiment includes: an pixel data sampling part 10 configured to convert the raster image data of raster scanning, which is inputted from the outside, into Lissajous image data for Lissajous scanning; a light source drive part 20 configured to drive a light source 60 such as an LD (laser diode) based on the Lissajous image data converted by the pixel data sampling part 10; a MEMS mirror 30 as a deflector irradiated with the laser light from the light source 60, which is configured to be resonantly driven for Lissajous scanning as drawing sine waves, in a horizontal direction as the main scanning direction and in a vertical direction as the sub-scanning direction orthogonal to the main scanning direction; a drive waveform generation part 40 configured to generate a drive waveform (resonance frequency) in the horizontal direction and the vertical direction to drive the MEMS mirror 30; and a clock oscillator 50 configured to generate a clock to synchronize the light source drive part 20 with the MEMS mirror 30. For the MEMS mirror 30, the repetition frequency of a Lissajous scanning pattern is ½ of the frame rate of raster scanning. A cycle period includes two fields, the first field and the second field. With the present embodiment, the MEMS mirror 30 is driven such that each scanning trajectory in the first field is drawn between the adjacent scanning trajectories in the second field and each scanning trajectory in the second field is drawn between the adjacent scanning trajectories in the first field. By this means, when an image of the raster image data for one frame is drawn in each field, it is possible to realize a resolution corresponding to the resolution of the raster image data with two continuous fields. This will be described in detail later.

The drive waveform generation part 40 outputs sine wave drive signals in the horizontal direction and the vertical direction of the MEMS mirror 30 to resonantly drive the MEMS mirror 30. Here, it is required to control the scanning pattern of the MEMS mirror 30 such that each scanning trajectory in the first field which is the front half of a cycle period is drawn between the adjacent scanning trajectories in the second field which is the back half, and each scanning trajectory in the second field is drawn between the adjacent scanning trajectories in the first field. Accordingly, the positions of the MEMS mirror 30 in the horizontal direction and the vertical direction, respectively, are represented by the following Equations 3 and 4, where the frequency of the cyclic period “a” represents a positive integer, and “T” represents time. Here, for the scanning trajectories described by Equation 3 and Equation 4, when time T from T0 to T1, one cycle period is provided. The repetition frequency is 1.

Horizontal position X=sin(2π·a·T) Equation 3

Vertical position Y=sin(2π·(a+1)πT) Equation 4

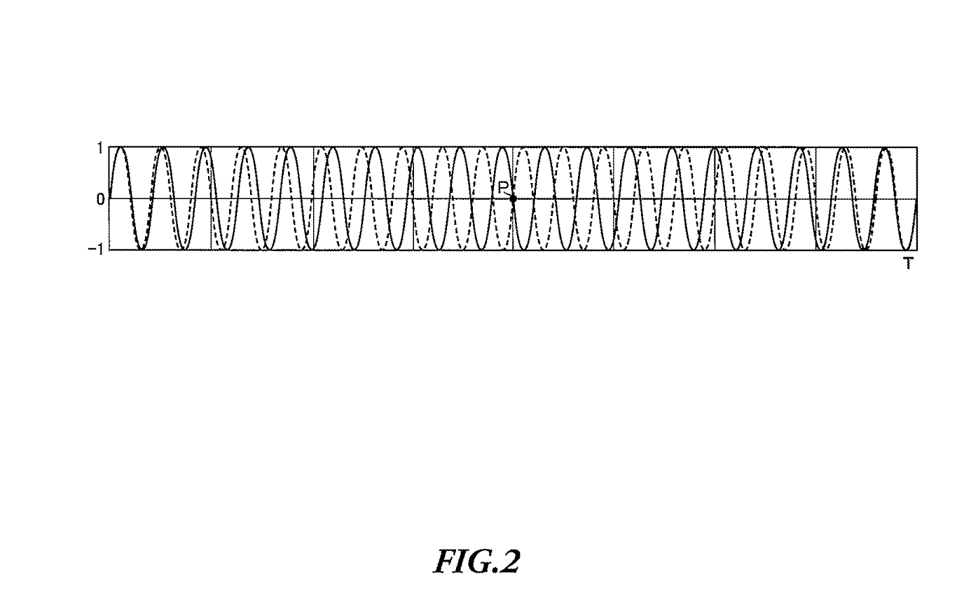

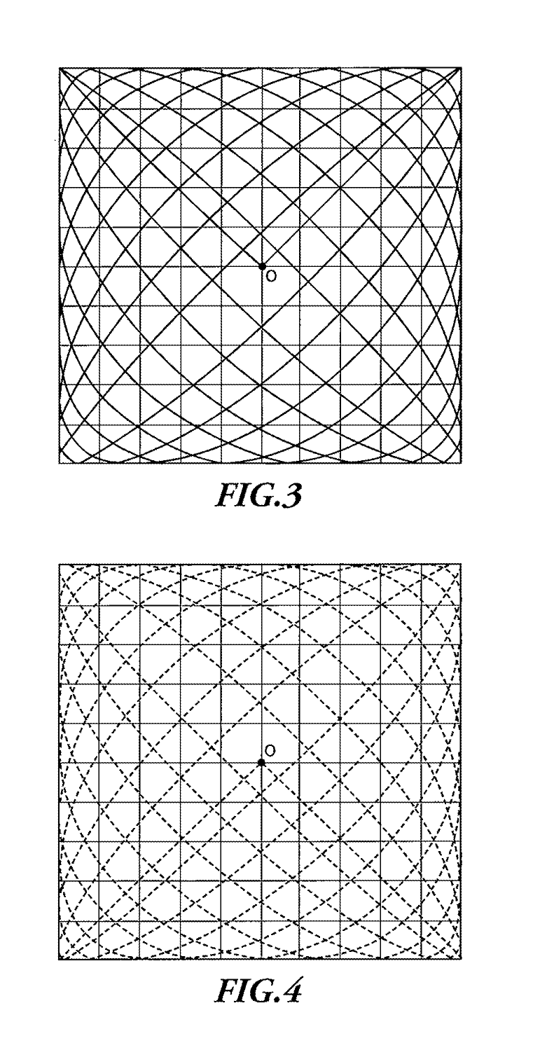

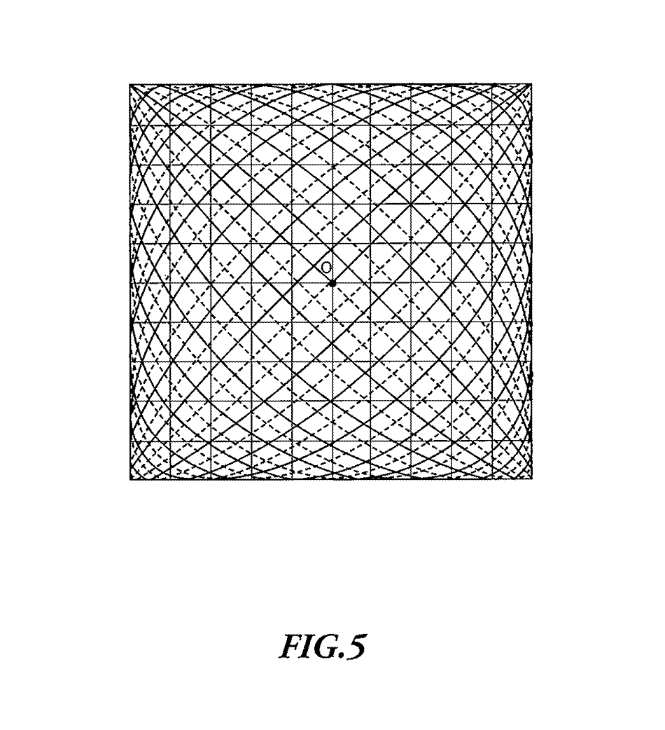

Now, the scanning trajectories described by Equation 3 and Equation 4 will be explained using an example of frequency “a”=19, for ease of visual understanding. FIG. 2 is a concept diagram showing horizontal positions X and vertical positions Y in the case of “a”=19, where the horizontal axis represents time T, the vertical axis represents amplitudes (−1 to 1), the solid line represents horizontal positions X and the broken line represents vertical positions Y. FIG. 3 is a schematic diagram showing the scanning trajectories in the first field for one cycle period, and FIG. 4 is a schematic diagram showing the scanning trajectories in the second field for one cycle period. FIG. 5 is a schematic diagram showing the scanning trajectories for one cycle period, with the overlap between the first filed and the second field. The scanning trajectories in the first field are drawn as solid lines, while the scanning trajectories in the second field are drawn as dashed lines. Here, the thin lines, which are drawn as an equally-spaced grid, are auxiliary lines. In each of those figures, the right and left direction is the horizontal direction, and the up and down direction is the vertical direction.

The Lissajous scanning trajectories are dense near the edges of the display at the apex of each sine wave shown in FIG. 2 because the drawing speed is low. Meanwhile, the Lissajous scanning trajectories are sparse near the center of the display at the half-way point of each sine wave because the drawing speed is high. The coordinate of a pixel drawn in the display is determined by the combination of horizontal position X and vertical position Y. Therefore, if there is a phase difference between horizontal position X and vertical position Y at the time each pixel is displayed, the pixel is displayed on a specific point.

Then, the difference in the cycle period between X and Y is “1”. Therefore, when time T changes from 0 to 1 (corresponding to one cycle period), the phase between horizontal position X and vertical position Y monotonically changes from 0 to 2π, which corresponds to one cycle. That is, there is a regular distance between the scanning trajectories next to one another for one cycle period. Moreover, the phase difference between horizontal position X and vertical direction Y monotonically increases while time T changes from 0 to ½ and while time T changes ½ to 1. Therefore, there is a regular distance between the scanning trajectories next to one another in the first and second fields.

At horizontal position X and vertical position Y represented in Equations 3 and 4, when the phase difference at T=0 is 0, the phase difference at T=1 is 2π, which corresponds to each cycle. The phase difference at T=½ is π, so that the gradient of one of Equation 3 and Equation 4 is maximized and the gradient of the other is minimized. That is, FIG. 2 is symmetric with respect to point P in a case of T=½ and X=Y=0, and Equations 3 and 4 are odd functions with the origin T=½ and X=Y=0. Accordingly, provided that the time apart from T=½ by plus t is t1=½−t and the time apart from T=½ by minus t is t2=½+t, relationship Xt1=−(Xt2) is held between horizontal position Xt1 at time t1 and horizontal position Xt2 at time t2, and also relationship Yt1−(Yt2) is held with respect to vertical position Y in the same way. That is, the pixel drawn at time T=t1 in the first field and the pixel drawn at time T=t2 in the second field are point-symmetric with respect to point 0 at the center of the display.

With Equations 3 and 4, the entire display is point-symmetric. The scanning trajectory, which is point-symmetric with the scanning trajectory drawn in the first quadrant of the first field, is drawn in the third quadrant of the second field. The scanning trajectory, which is point-symmetric with the scanning trajectory drawn in the second quadrant of the first field, is drawn in the fourth quadrant of the second field. The scanning trajectory, which is point-symmetric with the scanning trajectory drawn in the third quadrant of the first field, is drawn in the first quadrant of the second field. The scanning trajectory, which is point-symmetric with the scanning trajectory drawn in the fourth quadrant of the first field, is drawn in the second quadrant of the second field. Therefore, the scanning trajectory at 0≦T<½ in the first field is drawn in the middle of the scanning trajectory at ½≦T<1 in the second field. The resolution obtained by the scanning trajectories in the first field and the second field shown in the figures corresponds to a horizontal resolution of 19 lines because of the frequency “a” of one cycle period=19. Therefore, the resolution for one frame, which is obtained by the scanning trajectories in the first field and the second field, corresponds to a horizontal resolution of 36 lines that is twice as much as frequency “a”.

The pixel data sampling part 10 receives the raster image data for raster scanning, which includes frame rate n(fps) and horizontal resolution R lines, and generates Lissajous image data to be outputted to the light source drive part 20. For the raster image data for one frame, the pixel data sampling part 10 generates Lissajous image data of the Lissajous trajectories in one filed, which is described in the following Equation 5 and Equation 6.

Horizontal position X=sin(2π·a·n/2·T) Equation 5

Vertical position Y=sin(2π(a+1)·n/2·T) Equation 6

Here, “n/2” represents the repetition frequency of a Lissajous scanning pattern of the MEMS mirror 30. When the frame rate is 60 fps, the repetition frequency n/2 is 30. That is, in this case, the same Lissajous pattern is scanned 30 times in one second. Here, since the cycle period is “2/n”, the period for each field is “1/n”, which is 1/2 of the cycle period. Moreover, “a” is the frequency of the cycle period (the number of periods) as described above, and is set to 1/2 of the horizontal resolution in one frame. For example, when the desired horizontal resolution for one frame is substantially 1080 lines, “a” is 540. Therefore, the horizontal resolution for each field is substantially 540 lines, and consequently the horizontal resolution for one frame is substantially 1080 lines. Here, in this case, the drive frequency in the horizontal direction is 16.2 kHz (540×30=16.2 kHz), which is a lower value than the upper limit of the resonance frequency of the MEMS mirror.

In this way, the pixel data sampling part samples Lissajous image data for the first field by allocating the raster pixel data on the Lissajous trajectory represented by T=0 to 1/n in Equations 5 and 6 (in case of Equations 3 and 4, T=0 to 0.5), based on the inputted raster image data for the first frame, and samples Lissajous image data for the second field by allocating the raster pixel data on the Lissajous trajectory represented by T=1/n to 2/n in Equations 5 and 6 (in case of Equations 3 and 4, T=0.5 to 1), based on the raster image data for the second frame. For the subsequent frames, the pixel data sampling part samples Lissajous image data for the first field by allocating the raster pixel data on the Lissajous trajectory represented by T=0 to 1/n in Equations 5 and 6 to odd frames, and also samples Lissajous image data for the second field by allocating the raster pixel data on the Lissajous trajectory represented by T=1/n to 2/n in Equations 5 and 6 to even frames. By using the Lissajous image data for each field that is generated as described above, the Lissajous image data for n fields per second is outputted to the light source drive part 20. Then, the light source drive part 20 drives the light source 60 based on this Lissajous image data. The pixel data sampling part 10 is synchronized with the drive waveform generation part 40 with the clock oscillator 50. Therefore, the MEMS mirror 30 is controlled such that the image data for the odd fields is irradiated by the light source 60 when the

MEMS mirror 30 scans the first field, and the image data for the even fields is irradiated by the light source 60 when the MEMS mirror 30 scans the second field.

As described above, the repetition frequency of a Lissajous scanning pattern of the MEMS mirror 30 is set to n/2, which is half of frame rate n of raster scanning, and one cycle period (2/n) is constituted by the first field that is the front half of the one cycle period and the second field that is the back half. By this means, with a scanning trajectory of the

MEMS mirror 30, the field rate, which is the number of updated fields per unit time is the same as the frame rate. Then, the MEMS mirror 30 is controlled such that each scanning trajectory in the first field is drawn between the adjacent scanning trajectories in the second field and each scanning trajectory in the second field is drawn between the adjacent scanning trajectories in the first field by shifting frequency “a” of one cycle period by one between horizontal position X and vertical position Y. By this means, one frame constituted by two continuous fields has a high resolution, and therefore it is possible to draw a smoothly moving image without a flicker.

Here, during the drawing with Lissajous scanning as shown in the present embodiment, a drawing trajectory in the horizontal direction is formed a sine wave pattern as represented by Equation 4. Therefore, scanning speed Vx is maximized at the center of the display in the horizontal direction, meanwhile, the brightness of the display is higher in the edges of the display than in the center. Therefore, with the present embodiment, brightness correction for the pixel data is performed in proportion to inverse number (1/Vx) of scanning speed Vx to prevent a difference in the brightness between the center and the edges of the display in the horizontal direction. Then, also a drawing trajectory in the vertical direction changes in a sine wave pattern, and therefore the display is brighter in the edges than at the center, and therefore the brightness correction is required in the same way.

Although the embodiment of the present invention has been described in detail with reference to the drawings, specific configurations are not limited to this, but the present invention may include a design change without departing from the spirit of the present invention. For example, the specific number of scanning lines and frequencies are not limited to the embodiment, but may be changed appropriately.

In addition, a configuration has been described as an example where the main scanning direction is a horizontal direction and the sub-scanning direction is a vertical direction, and they are orthogonal to one another. However, this is by no means limiting. The main scanning direction and the sub-scanning direction are not necessarily orthogonal to one another as long as they are different from one another. For example, the sub-scanning direction may be inclined with respect to the main scanning direction at a predetermined angle.

Moreover, although a configuration has been described as an example where the front half of a cycle period is the first field and the back half is the second filed, it is by no means limiting. For example, part of the front half of a cycle period, which is drawn in a predetermined period, maybe the first field, and part of the back half, which is drawn in a predetermined period, may be the second field.

Furthermore, a configuration has been described as an example where the frequency of one cycle period is “a” at horizontal position X and is “a+1” at vertical position Y. However, it is by no means limiting. The frequency of a cycle period at horizontal position X and vertical position Y is not limited as long as the frequency is shifted by one between horizontal position X and vertical position Y. For example, the frequency at horizontal position X may be “a+1” while the frequency at vertical position Y may be “a”.

### REFERENCE SIGNS LIST

1 image display apparatus
10 pixel data sampling part
20 light source drive part
30 MEMS mirror (deflector)
40 drive waveform generation part
50 clock oscillator
60 light source

1. An image display apparatus comprising:
a light source;
a light source drive part configured to drive the light source;
a deflector configured to repeatedly scan light from the light source in predetermined Lissajous patterns, operating in a main scanning direction and a sub-scanning direction that is different from the main scanning direction;
a drive waveform generation part configured to generate a signal to drive the deflector; and
a clock oscillator configured to generate a clock signal to synchronize drive of the light source by the light source drive part with drive of the deflector, wherein:
one of the Lissajous patterns is constituted by a first field and a second field, the first field being formed by first scanning trajectories and the second field being formed by second scanning trajectories that are different from the first scanning trajectories;
the light source drive part drives the light source according to the clock signal, based on image data corresponding to a field rate that is a repetition frequency to repeat the first field and the second field;
the drive waveform generation part controls the deflector according to the clock signal such that main scanning position X in the main scanning direction, sub-scanning position Y in the sub-scanning direction, field rate n and time T hold relationships represented by following Equation 1 and Equation 2; and
the first field is formed by the first scanning trajectories at T from 0 to 1/n in one of the equation 1 and 2 and the second field is formed by the second trajectories at T from 1/n to 2/n
X=sin(2π·a·n/2·T), Y=sin(2π·(a+1)·n/2·T) Equation 1
X=sin(2π·(a+1)·n/2·T), Y=sin(2π·a·n/2·T) Equation 2
where a is a positive integer.

2. (canceled)
